(19) United States
(12) Patent Application Publication
(10) Pub. No.: US 2026/0236103 A1
(43) Pub. Date: Aug. 13, 2026

(54) HAPTIC TOUCHPAD

(71) Applicant: Semtech Corporation, Camarillo, CA (US)

(72) Inventors: Tom A. Kwa, San Jose, CA (US); Nandinee Kaushik, San Jose, CA (US)

(21) Appl. No.: 19/535,550

(22) Filed: Feb. 10, 2026

Related U.S. Application Data
(60) Provisional application No. 63/756,567, filed on Feb. 10, 2025.

(51) Int. Cl. G06F 3/01; G06F 1/16; G06F 3/0354; G06F 3/038; H04M 1/02

(52) U.S. Cl. CPC G06F 3/016; G06F 1/169; G06F 3/03547; G06F 3/038; H04M 1/0266

(57) ABSTRACT

A haptic touchpad and techniques to ensure desired level of intensity in actuation across the touchpad are disclosed. A model of a touchpad including: number and placement of actuators along with materials used, spring constants, and the like, is formed. Using an automated system, based on systemically varying touch inputs, varying input driver commands are provided to the actuators in the model in equation form, and outputs for the feedback are generated. Based on this, a look-up table (LUT) may be created that allows the feedback at any given point of the touchpad to be controlled. That is, for an input on the touchpad, the LUT contains an actuator input that will cause the actuators to generate a desired intensity level of actuation at the desired location of the touchpad. This desired level may be uniform across the touchpad.

### BACKGROUND

### Field of the Disclosure

The technology of the disclosure relates generally to touchpads, such as trackpads or touchscreens, which provide haptic feedback to their users.

### Background

Computing devices abound in modern society, and more particularly, mobile computing devices have become increasingly common. The prevalence of these mobile computing devices is driven in part by the many features often available on such devices. Many such devices include a touchpad of some sort. This touchpad can be a touchscreen as is common on mobile communication devices (e.g., smartphones) or tablets, or this touchpad can be a trackpad such as those found on laptop computers. Other variations may exist. Regardless of use, in many cases, the touchpad may include a haptic feedback. The feedback may, for example, take the form of a click (i.e., in classical mechanics, an “impulse” or change in momentum), a resistance to movement, or a sound. Further, in many cases, the number of feedback actuators used in association with the touchpad may be limited by space, cost, or other constraints. Such limitation in number of actuators used, may mean that the touchpad will provide inconsistent or non-uniform feedback intensity across the surface of the touchpad. Providing uniform feedback provides room for innovation.

### SUMMARY

Aspects disclosed in the detailed description include a haptic touchpad and certain techniques to ensure desired feedback across the touchpad. In exemplary aspects, a model of a touchpad including number and placement of feedback actuators along with materials used, spring constants, and the like, is formed. Using an automated system based on systemically varying touch inputs, varying input driver commands are provided to the feedback actuators in the model, and intensity levels for the feedback are generated. Based on this, a look-up table (LUT) may be created that allows the intensity level of the feedback at any given point of the touchpad to be controlled. That is, for an input on the touchpad, the LUT contains a feedback actuator input that will cause the feedback actuators to generate a desired intensity level at the desired location of the touchpad. In exemplary aspects, this desired intensity level may be uniform across the touchpad. In other aspects, a particular defined gradient is chosen by the programmers for the feedback. This allows areas of the touchpad that otherwise might have had weak or inconsistent feedback intensity levels to provide a consistent feedback intensity level and allow the user to have a satisfactory experience across the entire touch surface.

In this regard, in one aspect, a touchpad control circuit is disclosed. The touchpad control circuit includes a memory comprising a look-up table (LUT) and a circuit coupled to the memory and configured to be coupled to an input touch sensor and a plurality of actuators for a touchpad. The circuit is further configured to detect a touch on the touchpad through the input touch sensor and, responsive to a detected touch, generate individualized driving commands for each of the plurality of actuators to provide a desired haptic output at a target point on the touchpad.

In another aspect, a computing device is disclosed. The computing device includes a touchpad, a plurality of actuators proximate the touchpad and operable to drive the touchpad to give haptic feedback to a user responsive to a touch, an input touch sensor associated with the touchpad and operable to detect the touch, and a control circuit coupled to the input touch sensor and the plurality of actuators, the control circuit comprising a memory comprising a LUT. The control circuit configured to, responsive to a detected touch from the input touch sensor, generate individualized driving commands for each of the plurality of actuators to provide a desired haptic output at a target point on the touchpad.

In another aspect, a method of programming a LUT for a touchpad is disclosed. The method includes forming a model of the touchpad, including actuators, calibrating the model of the touchpad by providing inputs to the actuators in the model and recording simulated outputs of the touchpad at target points, determining which input provides a desired response at a given target point and storing the input that provides the desired response in a LUT for a control circuit.

### BRIEF DESCRIPTION OF THE DRAWINGS

FIG. 1A is a perspective view of a laptop computer that may have a trackpad that may benefit from the present disclosure;

FIG. 1B is a perspective view of a smartphone with a touch screen that may benefit from the present disclosure;

FIG. 2A is a top exploded view of a touchpad with haptic feedback actuators according to aspects of the present disclosure;

FIG. 2B is a side elevation cross-sectional view of the touchpad with haptic feedback actuators of FIG. 2A;

FIG. 3 is a block diagram of a computing device with actuators programmed according to aspects of the present disclosure;

FIG. 4 is a flowchart of a high-level process for determining drivers for the actuators of a computing device; and

FIG. 5 is a more detailed flowchart for a specific aspect of determining the drivers of the actuators.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that although the terms first, second, etc. may be used herein to describe various elements, these elements should not be limited by these terms. These terms are only used to distinguish one element from another. For example, a first element could be termed a second element, and similarly, a second element could be termed a first element without departing from the scope of the present disclosure. As used herein, the term “and/or” includes any and all combinations of one or more of the associated listed items.

It will be understood that when an element such as a layer, region, or substrate is referred to as being “on” or extending “onto” another element, it can be directly on or extend directly onto the other element, or intervening elements may also be present. In contrast, when an element is referred to as being “directly on” or extending “directly onto” another element, no intervening elements are present. Likewise, it will be understood that when an element such as a layer, region, or substrate is referred to as being “over” or extending “over” another element, it can be directly over or extend directly over the other element or intervening elements may also be present. In contrast, when an element is referred to as being “directly over” or extending “directly over” another element, no intervening elements are present. It will also be understood that when an element is referred to as being “connected” or “coupled” to another element, it can be directly connected or coupled to the other element, or intervening elements may be present. In contrast, when an element is referred to as being “directly connected” or “directly coupled” to another element, no intervening elements are present.

Relative terms such as “below” or “above” or “upper” or “lower” or “horizontal” or “vertical” may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms “a," “an,” and “the” are intended to include the plural forms as well unless the context clearly indicates otherwise. It will be further understood that the terms “comprises," “comprising," “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

To the extent that the term “approximately” is used in the claims, it is herein defined to be within ten percent (10%).

As a further note of nomenclature, it should be appreciated that actuation may be used in at least two ways. The first use is in the sense of a user touching, pressing, swiping, or interacting with the touchpad in such a manner that activates or “actuates” a response from the user interface (e.g., opening a file by pressing an icon; scrolling up or down a page; selecting a menu item; or the like). The second use is in the sense of actuation of the haptic feedback. That is, an actuator may be positioned proximate the touchpad and causes a vibration through the touchpad to provide the haptic feedback. Note that other forms of haptic feedback may also be provided (e.g., a sound or a resistance to movement (i.e., the cursor may not move as fast over an icon or image as the touch would otherwise dictate, e.g., the cursor slows as fruit is cut in FRUIT NINJA™). To the extent that the present disclosure uses both and needs to differentiate between the two uses, the present disclosure uses “touch actuation” and “feedback actuation.”

Aspects disclosed in the detailed description include a haptic touchpad and certain techniques to ensure desired feedback across the touchpad. In exemplary aspects, a model of a touchpad including number and placement of feedback actuators along with materials used, spring constants, and the like, is formed. Using an automated system based on systemically varying touch inputs, varying input driver commands are provided to the actuators in the model, and intensity levels for the feedback are generated. Based on this, a look-up table (LUT) may be created that allows the intensity level of the feedback at any given point of the touchpad to be controlled. That is, for an input on the touchpad, the LUT contains a feedback actuator input that will cause the actuators to generate a desired intensity level at the desired location of the touchpad. In exemplary aspects, this desired intensity level may be uniform across the touchpad. In other aspects, a particular defined gradient is chosen by the programmers for the feedback. This allows areas of the touchpad that otherwise might have had weak or inconsistent feedback intensity levels to provide a consistent feedback intensity level and allow the user to have a satisfactory experience across the entire touch surface.

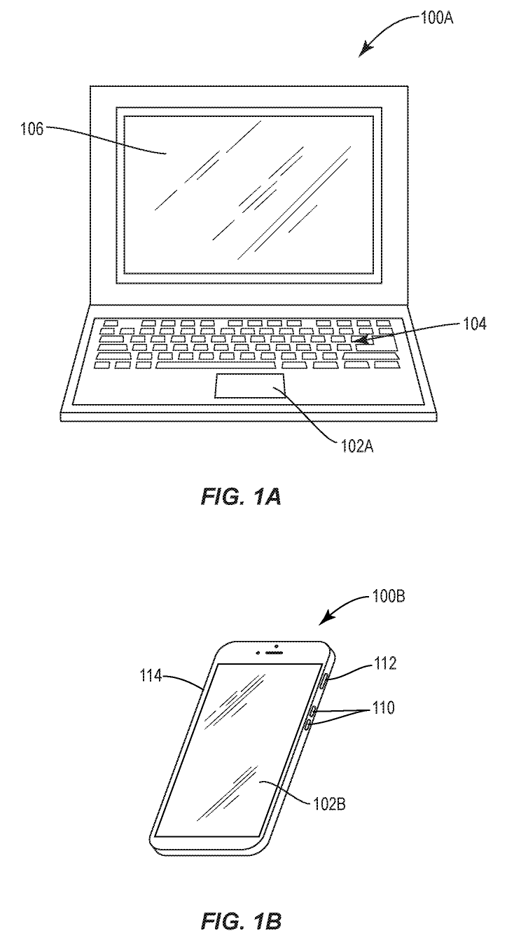

In this regard, FIGS. 1A and 1B illustrate two possible computing devices 100A, 100B respectively that may include respective touchpads 102A, 102B that provide haptic feedback for a user. The computing device 100A is a laptop computer with a trackpad operating as the touchpad 102A. The computing device 100A may include other user interface elements such as a keyboard 104 and a display 106. In an exemplary aspect, the display 106 may also be a touchpad. The computing device 100B is a smartphone with a touchscreen operating as the touchpad 102B. Additional user interface elements such as side volume buttons 110 and an on/off button 112 may be present in the housing 114 of the computing device 100B. While not shown, speakers and microphones may also be present in either or both computing devices 100A, 100B. It should be appreciated that while two specific examples are shown, other devices may also have touchpads (e.g., an automobile touchscreen).

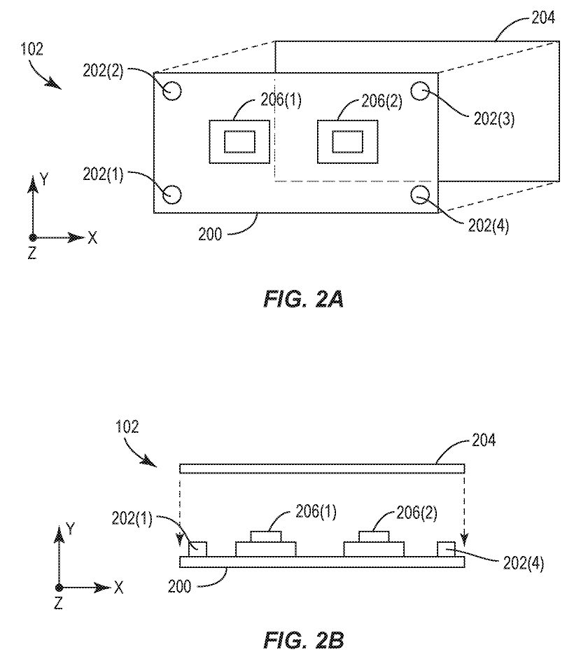

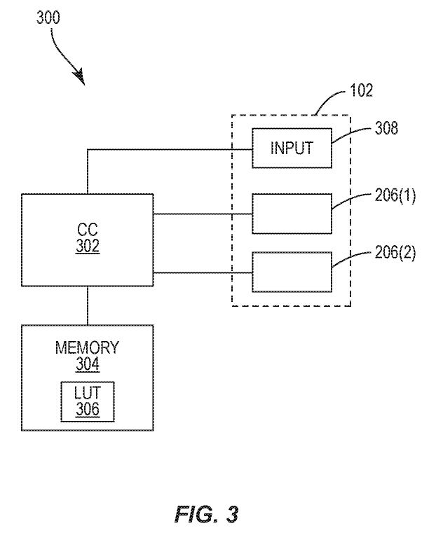

A generic touchpad 102 is shown in FIGS. 2A and 2B. The touchpad 102 has a bottom layer or base 200, which may be a printed circuit board (PCB) or the like. Rubber pads 202(1)-202(4) hold a top layer 204, which may, for example, be GORILLA GLASS. The touchpad 102 includes input sensors 308 (see FIG. 3) that detect pressure on the top layer 204 and can determine an x-y coordinate corresponding to where on the top layer 204 the touch has occurred, as is well understood. Responsive to the touch, direct-drive actuators (DDA) 206(1)-206(2) vibrate the top layer 204 to provide haptic feedback. DDA 206(1)-206(2) are feedback actuators as that term is defined above. Note that other types of feedback actuators other than DDA may be present instead.

In the absence of the present disclosure, responsive to a touch, the feedback actuators may apply a force to the top layer 204 at a fixed amplitude and phase. This fixed approach may create non-uniform feedback intensity levels across the top layer 204. For example, oscillations from the first DDA 206(1) may destructively interfere with oscillations from the second DDA 206(2) or standing waves may be created by oscillations reflecting off a fixed boundary edge. Generally, the user experiences these non-uniformities as reduced or absent responses near the edges of the top surface 204. Measured variations of existing touchpads range exceed +100%/-50%. That is, given a flat, uniform level of intensity in haptic feedback, some places experience more than double the intensity level of the flat, uniform feedback while other places have less than half the intensity level of the flat, uniform feedback.

Aspects of the present disclosure allow for an approximately flat response for a touchpad 102 by calibrating the feedback actuators using a model of the touchpad 102. The calibration is stored in a look-up table (LUT), and then responsive to a touch, the feedback actuators are activated at amplitudes and phases as indicated in the LUT. This ability to vary the operation of the feedback actuators allows for the desired feedback to be generated uniformly across the top surface 204. Alternatively, but still within the scope of the present disclosure, a defined but purposeful gradient or variation from a uniform feedback response may be provided. For example, a one-centimeter border region at the peripheral edge may have a 20% uniform reduction in feedback response compared to a uniform-response central region. As still another alternative, a dynamic feedback response may be provided responsive to a moving touch (e.g., while playing a game).

FIG. 3 provides a block diagram of a computing device 300 that includes a touchpad 102. The touchpad 102 is communicatively coupled to a control circuit 302 with associated memory 304 and a LUT 306 therewithin. The touchpad 102 includes input sensors 308 that can detect a touch (or touch actuation) on the top surface 204 (FIG. 2) and report same to the control circuit 302. Based on the location (and potentially velocity/direction) of the touch reported by the input sensors 308, the control circuit 302 finds a corresponding setting for the DDAs 206(1)-206(2) and generates a desired feedback intensity level for the user.

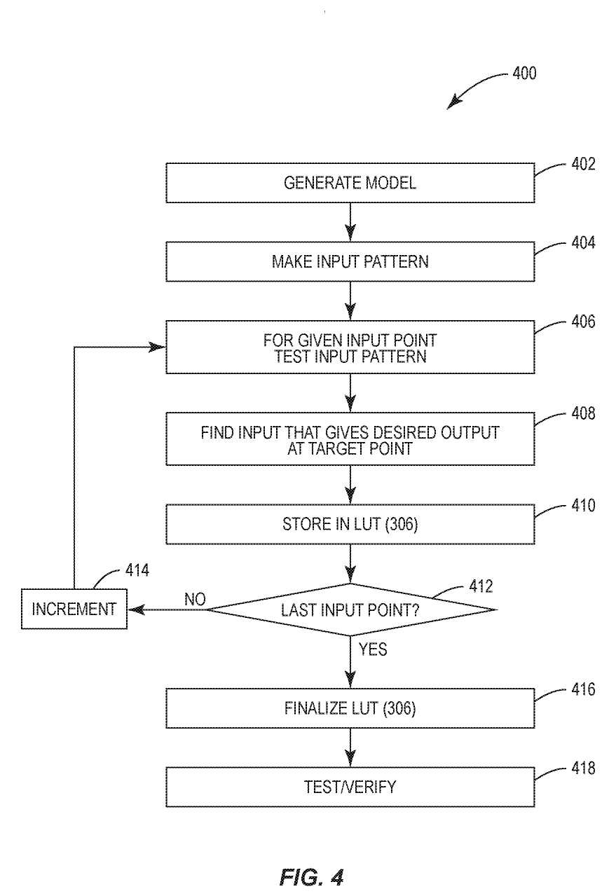

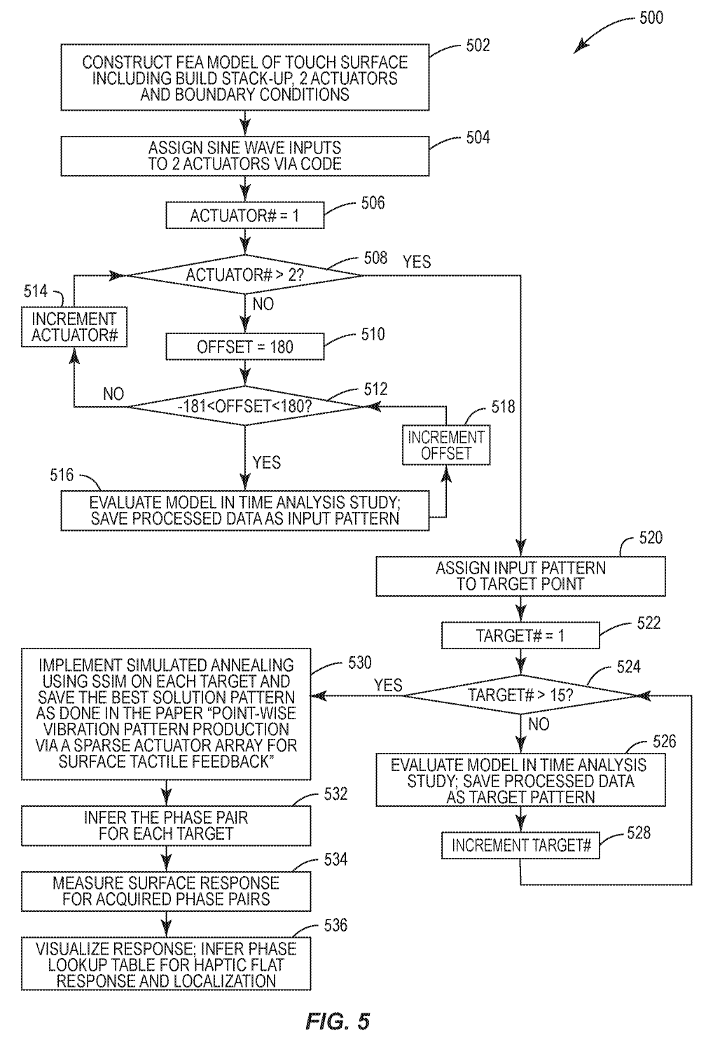

To generate the LUT 306, the present disclosure contemplates a calibration routine, as shown generally in FIG. 4 and with greater detail in FIG. 5. In this regard, FIG. 4 illustrates a process 400 that begins by generating a model of the touchpad 102 (block 402). This model may include, for example, the material properties of all layers of the touchpad 102 (e.g., the top layer 204), dimensions, and information (e.g., material and spring constants) about the DDAs 206(1), 206(2). Note that while the present disclosure assumes two feedback actuators, more can be used without departing from the present disclosure. Such additional feedback actuators add complexity but do not change the underlying principles of operation. The model may be made in a computer-aided design (CAD) program or simulation tool such as COMSOL MULTIPHYSICS found at www.comsol.com.

With continued reference to FIG. 4, the process 400 then generates an input pattern (block 404). The input pattern corresponds to inputs provided to the feedback actuators and, in an exemplary aspect, are sine waves with variable amplitudes and phases. The input pattern may, for example, include pairs of phases (i.e., one phase value for each feedback actuator) in one-degree increments across a range of amplitudes at predefined step increments.

Software may then be used to test the input pattern for a given input point (block 406). The touchpad 102 may be divided into a predefined number of input points. The larger the number of input points is, the greater the granularity of the end result will be, but the more complex it will be to generate the LUT. In an exemplary aspect, fifteen input points are uniformly distributed across the top surface 204. The testing involves using the model to generate outputs based on a given input.

Based on the testing, the calibration may find the input within the input pattern that generates a desired output at a target point (block 408). This value is then stored in the LUT 306 (block 410). If this is not the last input point (block 412), the input point is incremented (block 414), and the process 400 tests the next input point (block 406).

If, however, the last input point has been tested at block 412, the LUT 306 is finalized (block 416) and tested/verified against a real product (block 418).

FIG. 5 provides additional details about the steps for a particular exemplary aspect. It should be appreciated that the values used in the process 500 are just examples and others could be used. In this regard, the process 500 begins by constructing a finite-element analysis (FEA) model of the touch surface, including building stack-up, feedback actuators, and boundary conditions (block 502). As noted, this model may be generated in COMSOL MULTIPHYSICS or the like. Next, sine wave inputs are assigned to the two feedback actuators where the variable values are provided by code (block 504). The feedback actuator value is set to 1 (block 506), and the feedback actuator value is compared to the total number of feedback actuators present (e.g., 2) (block 508). At least initially, the answer to block 508 is “no”, so the offset is set to -180 degrees (block 510).

Once the offset equals or exceeds 180 degrees (block 512), the feedback actuator value is incremented (block 514) and tested again at block 508. However, initially, the answer to block 512 is “yes”, the offset remains within the range of -181<offset<180, and the calibration evaluates the model in a time-analysis study and is saved as an input pattern (block 516). That is, the simulation results that are saved are stress maps at given timesteps of, for example, Von Mises equivalent stress. The offset is then incremented (block 518) and retested at block 512 until the upper limit of 180 degrees has been reached. It should be appreciated that execution of the simulations in COMSOL MULTIPHYSICS may be automated using the Python programming language, in conjunction with its add-on ‘mph’ library allowing for varying input offset parameters to generate a comprehensive input dataset.

The process 500 continues once the input pattern is made for all the feedback actuators by assigning the input pattern to the target point (block 520). The target point is initially set to 1 (block 522) and tested against the total number of targets (e.g., 15) (block 524). While there are still targets to be tested, the simulation evaluates the model in a time-analysis study and saves processed data as a target pattern (block 526), and then increments the target number (block 528). This target data pattern may require modifying the COMSOL MULTIPHYSICS model to include boundary actuation inputs at specific target points.

Once all target points have been tested, the process 500 implements a simulated annealing using structural similarity index measure (SSIM) on each target and saves the best solution pattern (block 530). Based on this, a phase pair for each target may be inferred (block 532), and a surface response measured for each acquired phase pair (block 534). Finally, the response may be visualized and the LUT finalized for haptic flat response (block 536).

While an approximately uniform response may be generated, the present disclosure is not so limited, and a particular predefined gradient may be provided. Alternatively, certain target points may have greater or lesser intensity levels of feedback response if desired (e.g., the edge may be 20% lower than the central region by design rather than mere circumstance).

Still further, the feedback response may consider direction and velocity of the touch. For example, if a user is playing a touch-based game such as FRUIT NINJA, the feedback may spike as the user slices the fruit. Knowing how to create such spikes is readily achievable through the calibrations discussed herein.

It is also noted that the operational steps described in any of the exemplary aspects herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary aspects may be combined. It is to be understood that the operational steps illustrated in the flowchart diagrams may be subject to numerous different modifications, as will be readily apparent to one of skill in the art. Those of skill in the art will also understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations. Thus, the disclosure is not intended to be limited to the examples and designs described herein but is to be accorded the widest scope consistent with the principles and novel features disclosed herein.

What is claimed is:

1. A touchpad control circuit comprising:
a memory comprising a look-up table (LUT); and
a circuit coupled to the memory and configured to be coupled to:
an input touch sensor; and
a plurality of feedback actuators for a touchpad;
wherein the circuit is further configured:
to detect a touch on the touchpad through the input touch sensor;
responsive to a detected touch, generate individualized driving commands for each of the plurality of feedback actuators to provide a desired haptic output at a target point on the touchpad.

2. The touchpad control circuit of claim 1, wherein the LUT comprises the individualized driving commands.

3. The touchpad control circuit of claim 1, wherein the individualized driving commands provide feedback actuation with an equal level of intensity in all areas across the touchpad.

4. The touchpad control circuit of claim 1, wherein the individualized driving commands are different for different ones of the plurality of feedback actuators.

5. The touchpad control circuit of claim 1, wherein the individualized driving commands comprise an amplitude and phase variable.

6. The touchpad control circuit of claim 1, wherein the individualized driving commands provide different levels of intensity in feedback actuation for different target points on the touchpad.

7. The touchpad control circuit of claim 1 integrated into a computing device comprising a touchpad.

8. The touchpad control circuit of claim 7, wherein the computing device comprises a laptop computer and the touchpad comprises a trackpad.

9. The touchpad control circuit of claim 7, wherein the computing device comprises a smartphone and the touchpad comprises a touchscreen.

10. The touchpad control circuit of claim 1, wherein the touchpad control circuit is further configured to consider velocity of an input before selecting individualized commands from the LUT.

11. A computing device comprising:
a touchpad;
a plurality of feedback actuators proximate the touchpad and operable to drive the touchpad to give haptic feedback to a user responsive to a touch;
an input touch sensor associated with the touchpad and operable to detect the touch;
a control circuit coupled to the input touch sensor and the plurality of feedback actuators, the control circuit comprising a memory comprising a look-up table (LUT), the control circuit configured to:
responsive to a detected touch from the input touch sensor, generate individualized driving commands for each of the plurality of feedback actuators to provide a desired haptic output at a target point on the touchpad.

12. A method of programming a look-up table (LUT) for a touchpad, the method comprising:
forming a model of the touchpad, including feedback actuators;
calibrating the model of the touchpad by providing inputs to the feedback actuators in the model and recording simulated outputs of the touchpad at target points;
determining which input provides a desired response at a given target point; and
storing the input that provides the desired response in a LUT for a control circuit.

13. The method of claim 12, further comprising generating an input pattern to be used when providing inputs to the feedback actuators.

14. The method of claim 12, further comprising testing the inputs and outputs in a real touchpad.

15. The method of claim 12, further comprising iterating through multiple inputs when providing inputs.

16. The method of claim 12, further comprising measuring outputs at multiple target points.
